(19) United States
(12) Patent Application Publication
(10) Pub. No.: US 2019/0032801 A1
(43) Pub. Date: Jan. 31, 2019

(54) TANK TEE ASSEMBLY

(71) Applicant: Flomatic Corporation, Glens Falls, NY (US)

(72) Inventor: Allan Bo ANDERSSON, Cambridge, NY (US)

(73) Assignee: Flomatic Corporation, Glens Falls, NY (US)

(21) Appl. No.: 15/658,962

(22) Filed: Jul. 25, 2017

(51) Int. Cl. F16K 11/22; F16K 5/06; F16K 1/12; F16K 31/60; F16K 27/06

(52) U.S. Cl. CPC F16K 11/22; F16K 5/06; F16K 27/067; F16K 31/602; F16K 1/12

(57) ABSTRACT

A tank tee assembly includes a tank tee body including a tank tee inlet, a tank tee outlet and a tank tee passageway therebetween. The tank tee body also includes a first tank leg having a first tank leg passageway disposed in fluid communication with the tank tee passageway intermediate the tank tee inlet and tank tee outlet. The tank tee assembly also includes a ball valve assembly including a valve body including a valve inlet, a valve outlet and a valve passageway therebetween. A ball element is disposed within the valve passageway. A ball valve seat is disposed within the valve passageway between the tank tee outlet and the ball element. The valve inlet is in threaded engagement with the tank tee outlet such that the tank tee body urges the ball valve seat into sealing engagement against the ball element.

### TECHNICAL FIELD

The present invention relates to tank tee assemblies for water distribution systems. More specifically, the invention relates to tank tee assemblies for well pump installations.

### BACKGROUND

Tank tee assemblies are used in water distribution systems. Typically, a tank tee assembly is used in a well pump installation, where the tank tee assembly connects a pressurized water tank to the main water passageway from the well pump to the application. That application may be a domestic or industrial building plumbing system, a farm irrigation system, a booster pump system or the like.

Prior art (i.e., conventional) tank tee assemblies include a main passageway for the main well water flow and a single tank leg for the pressurized tank water. The single tank leg is usually teed into the main passageway. Various accessories (i.e., components) are connected to the conventional tank tee assembly to monitor and/or control the functional requirements of the application. For example, in almost all well pump installations, the conventional tank tee assembly is connected to a separate an isolation ball valve in order to be able to isolate the application from the well pump when needed. Additionally, in almost all well pump installations, a separate check valve is connected to the tank tee assembly in order to prevent backflow into the well from the pressurized tank. Other accessories may include pressure gages, pressure transducers and/or pressure switches, drain valves, relief valves and the like.

However, a plurality of connecting components, such as fittings, tubing and/or pipes, are required to connect the accessories to the conventional tank tee assembly. These additional connecting components take up space, require time and labor to assemble, and add cost to the entire installation project. In addition, the greater the number of threaded fittings and connections, the greater the risk of leakage. Further, the more connections utilized between the accessories and the conventional tank tee assembly, the greater the pressure drop of water flow through the installation will be and the lower the flow efficiency will be.

Accordingly, there is a need for a tank tee assembly that reduces space, eliminates connecting components, reduces manufacturing costs and increases flow efficiency relative to prior art tank tee assemblies. Additionally, there is a need for a tank tee assembly that eliminates the need for a separate isolation ball valve and/or separate check valve in a well pump installation system. Also there is a need for a tank tee assembly having a more compact and efficient design relative to prior art tank tee assemblies in order to reduce installation time into water distribution systems such as a well pump assembly.

### BRIEF DESCRIPTION

The present invention offers advantages and alternatives over the prior art by providing a tank tee assembly that includes a tank tee body attached to a ball valve assembly and/or an integrated poppet valve assembly. The tank tee body is utilized as a tailpiece for the ball valve assembly. The tank tee body is also utilized as a valve body for the poppet valve assembly. The tank tee body further includes a first tank leg and optionally a second tank leg. Both tank legs may include threaded taps for accessories. The tank tee assembly of the present invention reduces space, eliminates connecting components, reduces manufacturing costs, reduces installation time and increases flow efficiency relative to prior art tank tee assemblies.

A tank tee assembly in accordance with one or more aspects of the present invention includes a tank tee body including a tank tee inlet, a tank tee outlet and a tank tee passageway therebetween. The tank tee body also includes a first tank leg having a first tank leg passageway disposed in fluid communication with the tank tee passageway intermediate the tank tee inlet and tank tee outlet. The tank tee assembly also includes a ball valve assembly including a valve body including a valve inlet, a valve outlet and a valve passageway therebetween. A ball element is disposed within the valve passageway. A ball valve seat is disposed within the valve passageway between the tank tee outlet and the ball element. The valve inlet is in threaded engagement with the tank tee outlet such that the tank tee body urges the ball valve seat into sealing engagement against the ball element.

Another tank tee assembly in accordance with one or more aspects of the present invention includes a tank tee body including a tank tee inlet, a tank tee outlet and a tank tee passageway therebetween. A first tank leg having a first tank leg passageway disposed in fluid communication with the tank tee passageway intermediate the tank tee inlet and tank tee outlet. A poppet valve assembly is disposed in the tank tee passageway. The poppet valve assembly includes a poppet moveable between a closed position and an open position. When the poppet is in the closed position a flow of fluid from the tank tee inlet to the tank tee outlet is inhibited, and when the poppet is in the open position the flow of fluid is allowed.

Another tank tee assembly in accordance with one or more aspects of the present invention includes a tank tee body including a tank tee inlet, a tank tee outlet and a tank tee passageway therebetween. A first tank leg having a first tank leg passageway is disposed in fluid communication with the tank tee passageway intermediate the tank tee inlet and tank tee outlet. A second tank leg having a second tank leg passageway is disposed in fluid communication with the tank tee passageway intermediate the tank tee inlet and tank tee outlet. A ball valve assembly includes a valve body including a valve inlet, a valve outlet and a valve passageway therebetween. A ball element is disposed within the valve passageway. A ball valve seat is disposed within the valve passageway between the tank tee outlet and the ball element. A poppet valve assembly is disposed in the tank tee passageway. The poppet valve assembly includes a poppet moveable between a closed position and an open position. The valve inlet is in threaded engagement with the tank tee outlet such that the tank tee body urges the ball valve seat into sealing engagement against the ball element. When the poppet is in the closed position a flow of fluid from the tank tee inlet to the tank tee outlet is inhibited, and when the poppet is in the open position the flow of fluid is allowed.

### DRAWINGS

The invention will be more fully understood from the following detailed description taken in conjunction with the accompanying drawings, in which:

FIG. 1 is a perspective view of an exemplary embodiment of a prior art tank tee assembly;

FIG. 2 is a perspective view of an exemplary embodiment of a prior art isolation ball valve and a prior art check valve schematically connected to the prior art tank tee assembly of FIG. 1;

FIG. 3 is a perspective view of an exemplary embodiment of a tank tee assembly in accordance with the present invention;

FIG. 4A is a perspective view of an exemplary embodiment of the tank tee assembly of FIG. 3 with a plurality of exemplary tank tee accessories mounted thereon in accordance with the present invention;

FIG. 4B is a bottom view of the exemplary embodiment of the tank tee assembly of FIG. 4A in accordance with the present invention;

FIG. 4C is a front view of the exemplary embodiment of the tank tee assembly of FIG. 4A in accordance with the present invention;

FIG. 4D is another side view of the exemplary embodiment of the tank tee assembly of FIG. 4A in accordance with the present invention;

FIG. 4E is another side view of the exemplary embodiment of the tank tee assembly of FIG. 4A in accordance with the present invention;

FIG. 5 is a cross sectional view of an exemplary embodiment of the tank tee assembly of FIG. 4C taken along the line 5-5 of FIG. 4C in accordance with the present invention;

FIG. 6A is a perspective view of an exemplary embodiment of the tank tee assembly of FIG. 5 having a cut away view of a ball valve assembly shown in circle 6A of FIG. 5 in accordance with the present invention;

FIG. 6B is an exploded view of the exemplary embodiment of the ball valve assembly of FIG. 6A in accordance with the present invention;

FIG. 7 is side cross sectional view of an alternative exemplary embodiment of the ball valve assembly shown in circle 6A of FIG. 5 in accordance with the present invention;

FIG. 8A is perspective view of an exemplary embodiment of a poppet valve assembly shown within circle 8A of FIG. 5 in accordance with the present invention; and

FIG. 8B is an exploded view of the exemplary embodiment of the poppet valve assembly of FIG. 8A.

### DETAILED DESCRIPTION

Certain exemplary embodiments will now be described to provide an overall understanding of the principles of the structure, function, manufacture, and use of the methods, systems, and devices disclosed herein. One or more examples of these embodiments are illustrated in the accompanying drawings. Those skilled in the art will understand that the methods, systems, and devices specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

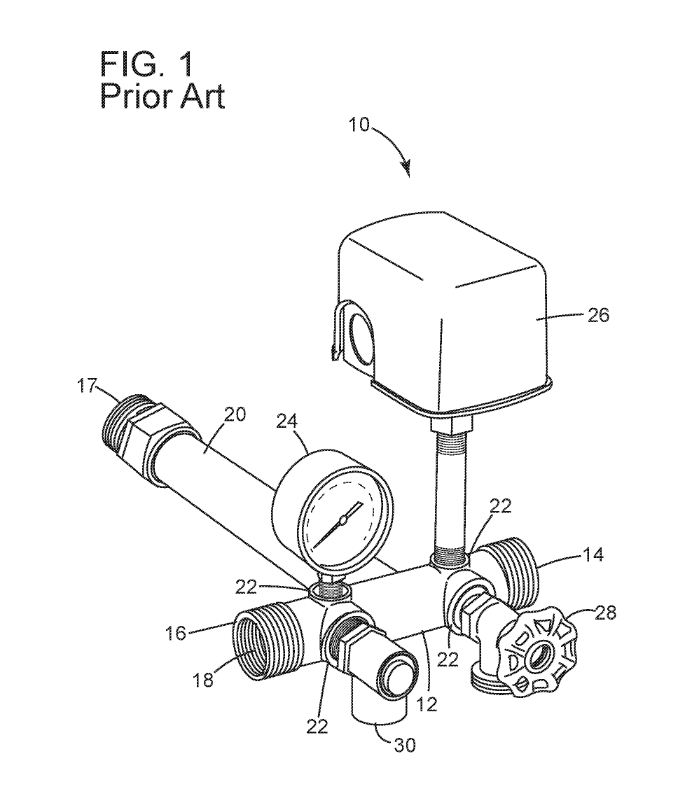

Referring to FIG. 1, an exemplary embodiment of a prior art tank tee assembly 10 is presented. The tank tee assembly 10 includes a tank tee body 12. The tank tee body includes a threaded tank tee inlet 14, a threaded tank tee outlet 16 and a tank tee passageway 18 therebetween.

The tank tee inlet 14 is disposed at the upstream end of the passageway 18 and receives water from a well pump installation (not shown). The tank tee outlet 16 is disposed at the downstream end of the passageway 18, wherein the main flow of water exits the passageway 18 and flows toward a water distribution system (not shown).

The assembly 10 also includes a tank leg 20 having a threaded tank leg outlet 17 that is disposed in fluid communication with the tank tee passageway 18 intermediate the tank tee inlet 14 and tank tee outlet 16. The tank leg outlet 17 is connected to plumbing that is in fluid communication with a pressurized water tank (not shown). The pressurized tank maintains a predetermined pressure (typically about 30 to 60 psi) on the water distribution system.

In this prior art embodiment, the tank tee inlet 14, the tank tee outlet 16 and the tank leg outlet 17 are all interchangeable. For example, the tank leg outlet 17 may be used as the tank tee inlet 14 or the tank tee inlet 16. That is because the prior art tank tee body 12 is a basic tee with no restrictions on flow direction. Therefore, the designation of which threaded inlet or outlet 14, 16, 17 will function as the tank tee inlet, tank tee outlet or tank leg outlet is a matter of choice.

Various threaded taps 22, are disposed in the tank tee body 12. The taps are sized to receive various accessories such as a pressure gage 24, a pressure switch 26, a boiler drain 28 and a relief valve 30.

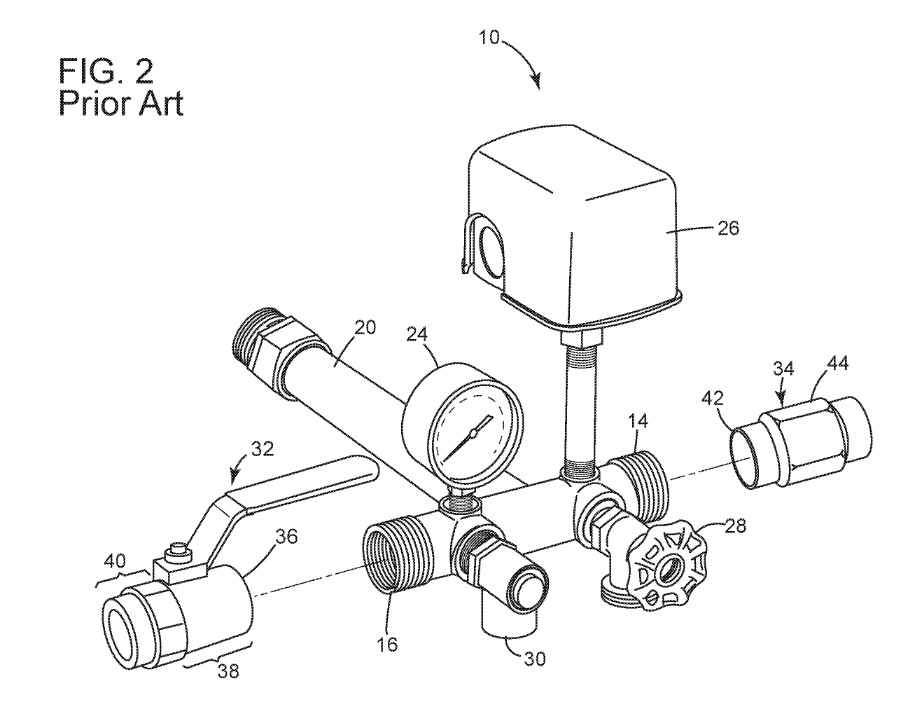

Referring to FIG. 2, a conventional isolation ball valve 32 and conventional check valve 34 that are usually connected to the prior art tank tee assembly 10 are shown. In almost all well pump installations, the outlet 16 of the tank tee assembly 10 is connected by various additional fittings and pipes (not shown) to a ball valve inlet 36 of a conventional ball valve 32.

The conventional ball valve 32 includes a main ball valve body 38 that is in threaded engagement with a ball valve tailpiece 40. A ball element is captured within a ball valve passageway of the ball valve body 38 by a pair of ball valve seats that are disposed on opposing upstream and downstream sides of the ball element. The threaded engagement of the tailpiece 40 to the ball valve body 38 is such that the tailpiece urges the ball valve seats into sealing engagement against the ball element.

Additionally, in almost all well pump installations, the outlet 42 of a check valve 34 is connected by various other fittings and pipes (not shown) to the inlet 14 of the tank tee assembly 10. The conventional check valve 34 includes a check valve body 44 that provides support for a poppet valve assembly.

Problematically however, the fittings and pipes that are used to connect the conventional check valve 34, ball valve 32 and tank tee assembly 10 together can add a significant amount of space to the well pump installation. Further, the cost of the installation is increased with each new fitting and/or pipe that has to be added, while the flow efficiency is decreased. In addition, leakage risks increase with the number of pipe connections.

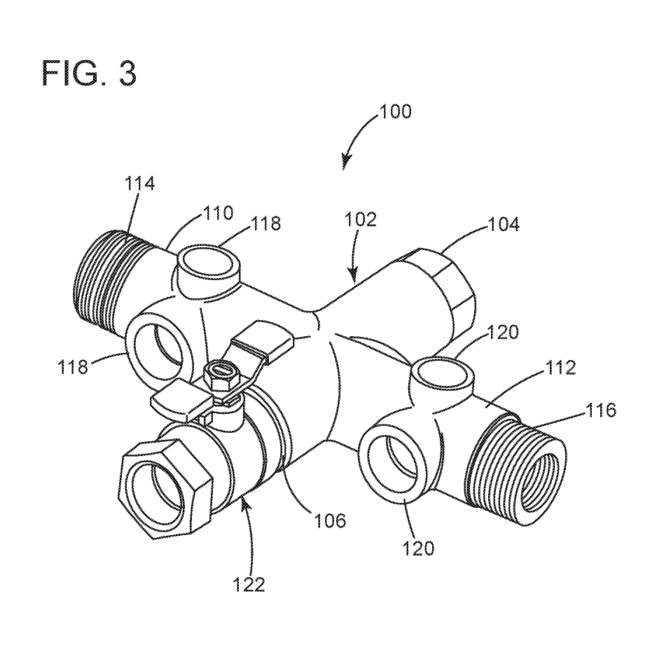

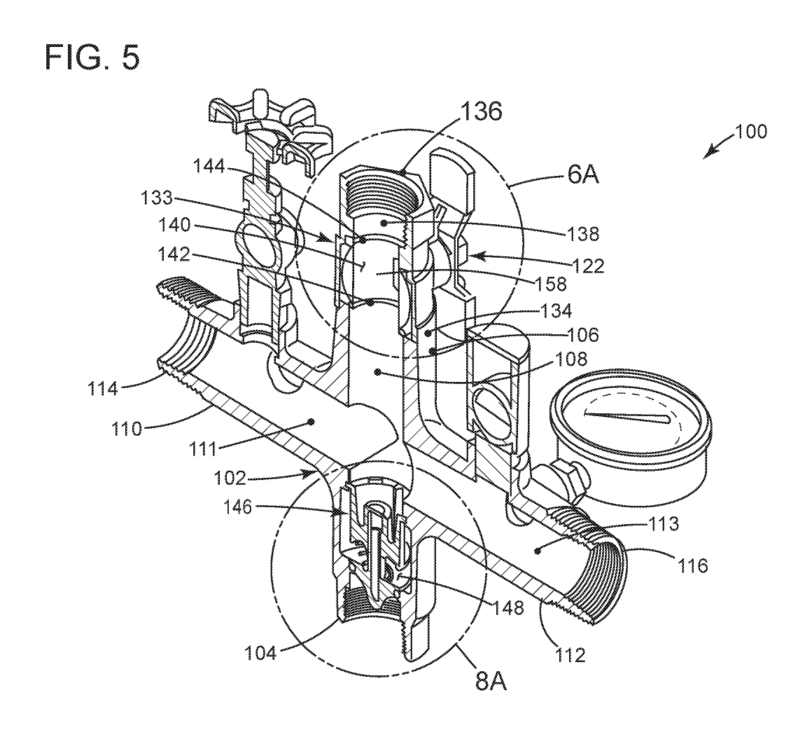

Referring to FIG. 3, an exemplary embodiment of a tank tee assembly 100 in accordance with the present invention is presented. The tank tee assembly 100 includes a tank tee body 102. The tank tee body 102 includes a tank tee inlet 104, a tank tee outlet 106 and a tank tee passageway 108 (best seen in FIG. 5) therebetween. More specifically, the tank tee inlet 104 is disposed on the downstream end of the tank tee passageway 108 where a flow of water (from a well pump for example) enters the passageway 108. The tank tee outlet 106 is disposed on the upstream end of the passageway 108 where the water flow exits the passageway 108 and enters a ball valve assembly 122.

The tank tee body 102 also includes a first tank leg 110 having a first tank leg passageway 111 (best seen in FIG. 5) and an optional second leg 112 having a second tank leg passageway 113 (best seen in FIG. 5). Both the first and second tank leg passageways 111, 113 are disposed in fluid communication with the tank tee passageway 108 intermediate the tank tee inlet 104 and tank tee outlet 106.

Note that this embodiment shows a tank tee assembly 100 having a first and a second tank legs 110, 112. However, other embodiments of the tank tee assembly 100 may include only a single tank leg.

The first and second tank legs 110, 112 include threaded end portions 114, 116 respectively. The first end portion 114 is designed to connect to a pressurized water tank (not shown), which is generally used in a well pump installation. The second end portion 116 may be optionally connected to a second pressurized water tank or other similar component. Alternatively, the second end portion 116 may be plugged.

A first pair of threaded taps 118 is disposed in the first tank leg 110. A second pair of threaded taps 120 is disposed in the second tank leg 112. As will be discussed in greater detail herein, the first and second pair of threaded taps 118, 120 are sized to receive a plurality of tank tee accessories, depending on the requirements of the application.

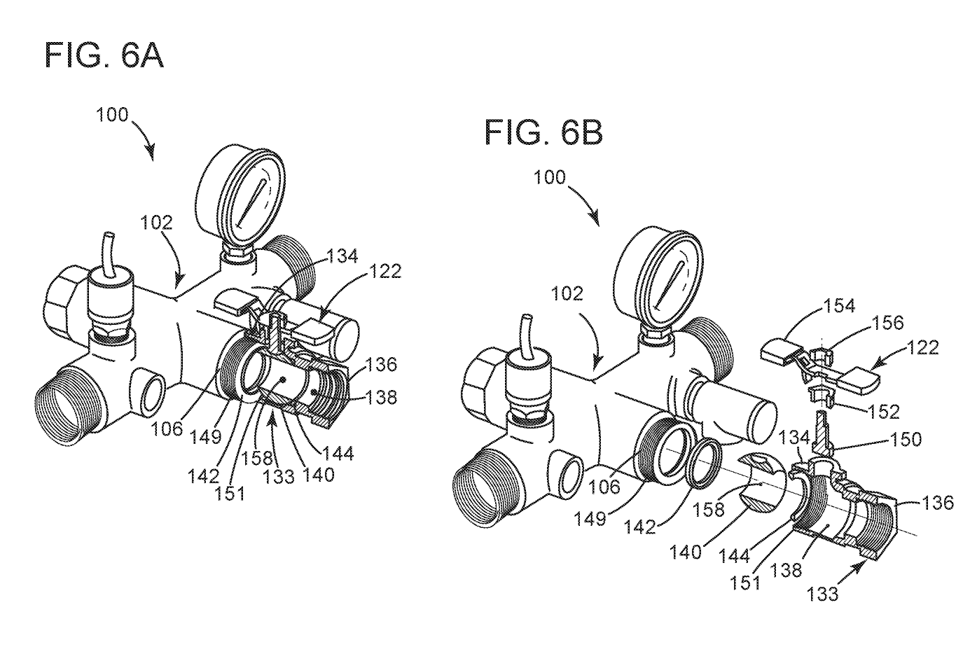

The ball valve assembly 122 is in threaded engagement with the tank tee outlet 106 of the tank tee body 102 such that, when the flow of water exits the tank tee outlet 106, it then passes through a valve passageway 138 (best seen in FIGS. 5, 6A and 6B). As will be discussed in greater detail herein, the ball valve assembly 122 does not include a conventional ball valve tailpiece. Rather the tank tee body 102 functions as the tailpiece of the ball valve assembly 122.

Advantageously, by utilizing the tank tee body 102 as the tailpiece for the ball valve assembly 122, any fittings, pipes and/or other plumbing components that would be used to connect a conventional ball valve to a conventional tank tee assembly are eliminated. Additionally, the tailpiece of such a conventional ball valve is also eliminated.

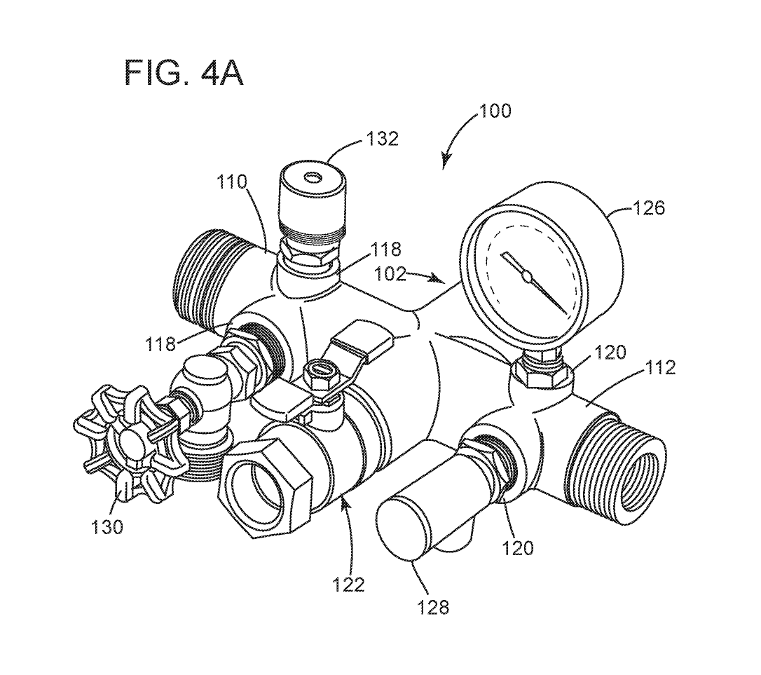

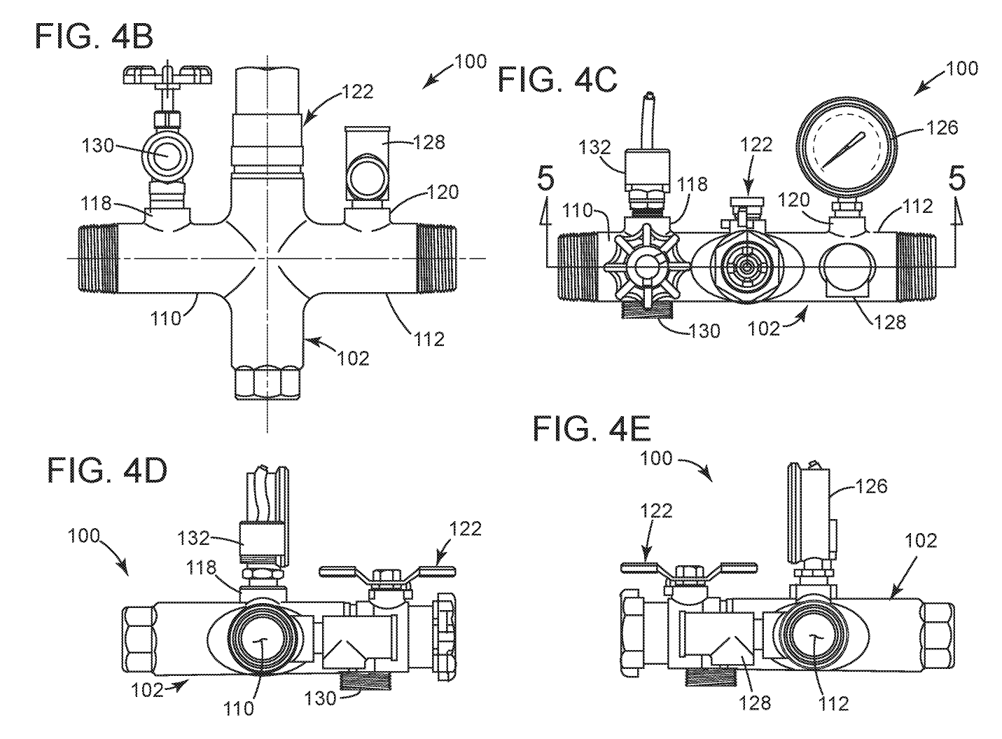

Referring to FIGS. 4A, 4B, 4C, 4D and 4E, various views of the tank tee assembly 100 with a plurality of exemplary tank tee accessories 126, 128, 130, 132 mounted in the first and second taps 118, 120 are presented. More specifically:

FIG. 4A is a perspective view of tank tee assembly 100;

FIG. 4B is a bottom view of the tank tee assembly 100;

FIG. 4C is a front view facing the ball valve assembly 122 end;

FIG. 4D is a side view facing the first tank leg 110 end; and

FIG. 4E is a side view facing the second tank leg 112 end.

The accessories include a pressure gage 126, a relief valve 128, a drain valve 130 and a pressure transducer 132. In this embodiment, the taps have female pipe threads (for example one quarter inch female national pipe threads (NPT) that are sized to receive the tank tee accessories.

Referring to FIG. 5, a cross sectional view of the tank tee assembly 100 taken along the line 5-5 of FIG. 4C is presented. The ball valve assembly 122 includes a valve body 133. The valve body includes a valve inlet 134, a valve outlet 136 and a valve passageway 138 therebetween.

More specifically, the valve inlet 134 of the ball valve assembly 122 is in threaded engagement with the tank tee outlet 106 of the tank tee body 102. As such, when the water flow from a well exits the tank tee outlet 106, it enters the valve passageway 138 through the valve inlet 134 and exits the valve passageway 138 through the valve outlet 136.

The ball valve assembly 122 also includes a ball element 140 that is disposed within the valve passageway 138. The ball element 140 has a hollow central core 158 that aligns with the valve passageway 138 when the ball element 140 is in an open position. A first ball valve seat 142 is disposed within the valve passageway 138 between the tank tee outlet 106 of the tank tee body 102 and the ball element 140 of the ball valve assembly 122. A second ball valve seat 144 is also disposed within the valve passageway 138 between the valve outlet 136 and the ball element 140 of the ball valve assembly 122.

Advantageously due to the design of the threaded engagement between the valve inlet 134 and the tank tee outlet 106, the tank tee body 102 functions as a tailpiece for the ball valve assembly 122. That is, the valve inlet 134 is in threaded engagement with the tank tee outlet 106 such that the tank tee outlet 106 of the tank tee body 102 urges the first ball valve seat 142 into sealing engagement against the ball element 140. Once the sealing engagement of the first ball valve seat 142 against the ball element 140 is made by the tank tee body 102, the ball element 140 is effectively sandwiched into a sealing engagement between the first ball valve seat 142 and the second ball valve seat 144.

The tank tee assembly 100 also includes a poppet valve assembly 146 disposed in the tank tee passageway 108. The poppet valve assembly 146 includes a poppet 148 moveable between a closed position and an open position. Accordingly, when the poppet 148 is in the closed position the backflow of fluid from the tank tee outlet 106 to the tank tee inlet 104 is inhibited, and when the poppet is in the open position the flow of fluid from the tank tee inlet 104 to the tank tee outlet 106 is allowed.

Referring to FIG. 6A, an exemplary embodiment of a perspective view of the tank tee assembly 100 having a cut away view of the ball valve assembly 122 shown in circle 6A of FIG. 5 is presented. In this particular exemplar embodiment, the tank tee outlet 106 of the tank tee body 102 includes a male threaded end portion 149 disposed on an outer surface of the tank tee body 102. The male threaded end portion 149 includes a set of pipe threads. Additionally, the valve inlet 134 of ball valve assembly 122 includes a mating female threaded end portion 151 disposed on an inner peripheral surface of the valve body 122. The female threaded end portion also includes a set of threads. When the tank tee outlet 106 is threaded into the valve inlet 134, the first ball valve seat 142 is urged by the end portion of outlet 106 into sealing engagement against the ball element 140. Additionally, the ball element 140 presses against the second ball valve seat 144 to sealingly engage with it. The ball element 140 is then effectively sandwiched between the first and second ball valve seats 142, 144.

Referring to FIG. 6B, an exploded view of the ball valve assembly 122 of FIG. 6A is shown. The ball valve assembly 122 further includes a stem 150, a packing 152, a handle 154 and a nut 156, which are operatively assembled to pivot the ball element 140 within valve passage 138 between an open position and a closed position.

The hollow central core 158 of the ball element 140 aligns with the valve passageway 138 when the ball element is in the open position to allow flow from the valve inlet 134 to the valve outlet 136. When the valve is in the closed position, the core 158 is pivoted approximately 90 degrees to block flow through the valve passageway 138.

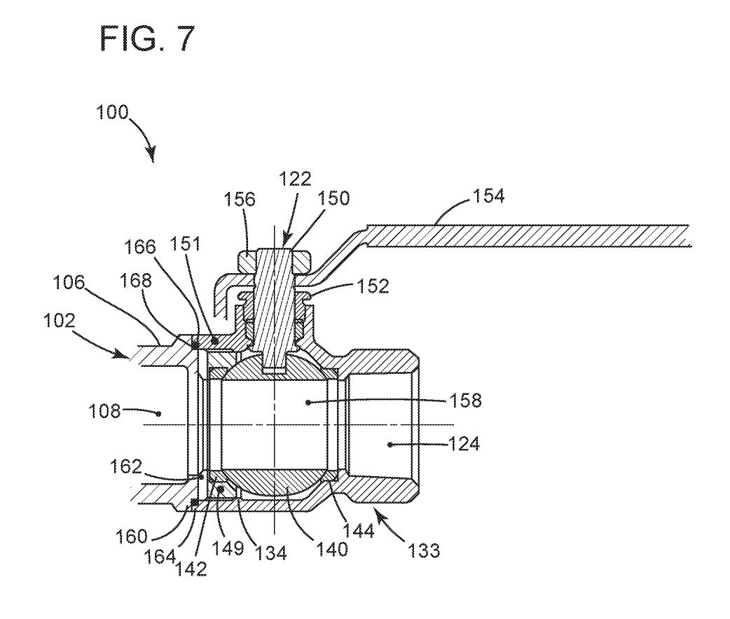

Referring to FIG. 7, an alternative embodiment of the tank tee assembly 100 is presented. In this embodiment the male threaded end portion 149 of the tank tee outlet 106 and the female threaded end portion 151 of the valve inlet 134 are composed of straight threads.

In addition to the tank tee inlet 106 having a male straight threaded end portion 149, the tank tee inlet 106 also includes an outer annular shoulder 160 disposed on the outer surface of the tank tee body 102. The outer annular shoulder 160 is disposed proximate the male threaded end portion 149. Further, an inner annular shoulder 162 is disposed on an inner peripheral surface of the tank tee passageway 108. The inner peripheral surface defining the tank tee passageway 108 through the tank tee body 102.

The valve inlet 134 has a mating female straight threaded end portion 151 disposed on the inner peripheral surface of the valve body 133. The inner peripheral surface defining the valve passageway 124 through the valve body 133.

Accordingly, when the male straight threaded end portion 149 of the tank tee outlet 106 engages with the female straight threaded end portion 151 of the valve inlet 134, a distal end 164 of the female threaded end portion 151 of the valve inlet 134 abuts against the outer annular shoulder 160 of the tank tee outlet 106. Additionally, the inner annular shoulder 162 of the tank tee outlet 106 abuts against the ball valve seat 142.

An “o” ring groove 166 is disposed in the distal end 164 of the female threaded end portion 151 and an “o” ring 168 is disposed in sealing engagement in the “o” ring groove 166. Therefore, when the male and female threaded end portions 149, 151 are in threaded engagement, the “o” ring 168 provides the seal that prevents water from leaking out of the tank tee assembly 100 where the end portions 149, 151 join.

Though the threaded engagement between the tank tee outlet 106 and valve inlet 134 has been described in the exemplary embodiments illustrated in FIGS. 6A, 6B and 7, other thread embodiments are also within the scope of this invention. For example, a threaded sleeve, having female threads, may be fit over a shoulder of the tank tee outlet 106 that is designed to thread over male threads on the valve inlet 134.

Advantageously, by designing the tank tee outlet 106 of the valve body 102 to press against and urge the first ball valve seat 142 against the ball element 140, the valve body 102 replaces the tailpiece of a conventional ball valve. Therefore, the conventional tailpiece, and the components required to connect the conventional tailpiece to the conventional tank tee assembly, may be eliminated.

Though the exemplary embodiments illustrated in FIGS. 6A, 6B and 7 show the tank tee outlet 106 pressing directly against the first ball valve seat 142 to seal against ball element 140, other embodiments are also within the scope of this invention. For example, a spacer (not shown) may be disposed between the tank tee outlet 106 and first ball valve seat 142, wherein the tank tee outlet 106 presses directly against the spacer (not shown) and the spacer urges the ball valve seat 142 into sealing engagement against the ball element 140.

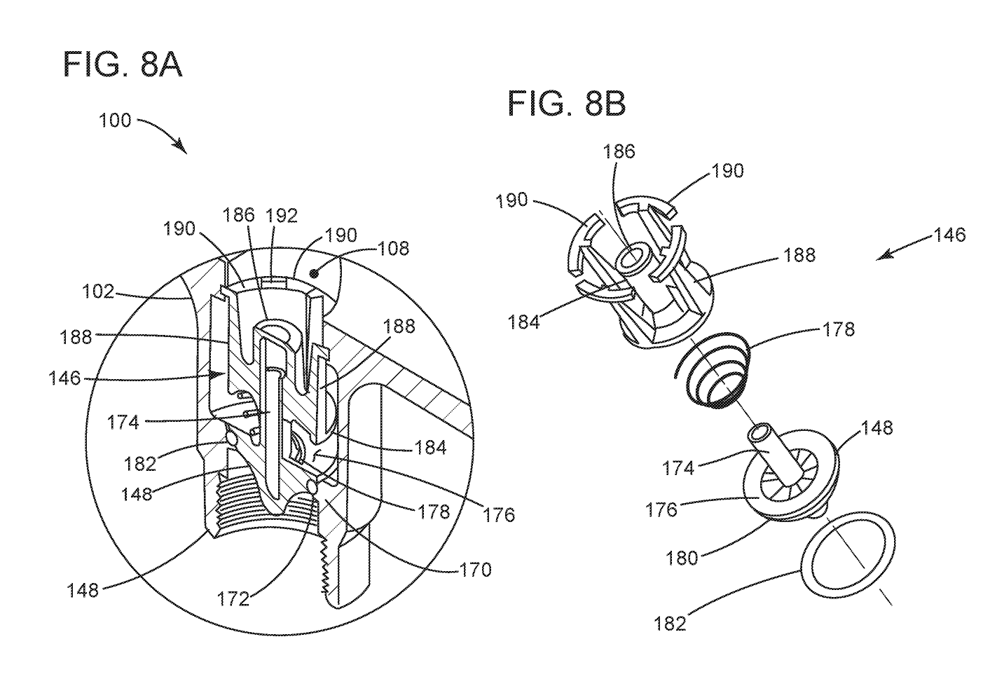

Referring to FIGS. 8A and 8B, views of an exemplary embodiment of the poppet valve assembly 146 disposed in the tank tee passageway 108 are presented. More specifically, FIG. 8A is a perspective view of the poppet valve assembly 146 shown within circle 8A of FIG. 5. FIG. 8B is an exploded view of the poppet valve assembly of FIG. 8A.

The poppet valve assembly 146 is disposed in the tank tee passageway 108 proximate the tank tee inlet 102. The poppet 148 of the poppet valve assembly 146 sealingly engages with an annular flange 170. The annular flange 170 is disposed on the peripheral surface of the tank tee passageway 108 and has a poppet valve seat 172. The poppet valve seat 172, in this particular embodiment, is in the form of a flange “o” ring groove 172.

The poppet 148 includes a disk 176 and a stem 174 extending from the disk 176. The disk 174 is resiliently biased by a spring 178 to sealingly engage against the poppet valve seat (or flange “o” ring groove) 172 when the poppet 148 is in the closed position. The disk 176 is disengaged from the poppet valve seat 172 when the poppet 148 is in the open position.

The disk 174 includes a poppet “o” ring groove 180 having a poppet “o” ring 182 disposed therein. The poppet “o” ring 182 mates with the flange “o” ring groove (or poppet valve seat) 172 to seal of the flow of water when the poppet 148 is in the closed position.

The poppet valve assembly also includes a guide 184. The guide 184 includes a sleeve 186, which movably engages the stem 174 as the disk 176 reciprocates from the closed position to the open position. The guide 184 also includes support arms 188 extending radially from the sleeve 186. The support arms 188 having arcuate tabs 190 disposed on distal ends of the support arms 188.

An annular groove 192 is disposed in the peripheral surface of the tank tee passageway 108, just downstream of the annular flange 170. The tabs 190 are sized to fit within the annular groove 192 to rigidly mount the guide 184 within the tank tee passageway 108.

The spring 178 is disposed between the rigidly mounted guide 184 and the moveable poppet 148 in a self-nesting fashion. This helps to make the poppet valve assembly 146 quick acting and compact.

Advantageously, by disposing the poppet valve assembly 146 within the tank tee passageway 108, the tank tee body 102 serves as the body of the poppet valve assembly 146. Therefore, the conventional check valve, and the components required to connect the conventional check valve to the conventional tank tee assembly, may be eliminated.

Further, some additional advantages included in an exemplary embodiment of the tank tee assembly 100 which includes the ball valve assembly 122, the poppet valve assembly, the first tank leg 110 and the second tank leg 112, are as follows:
1. The tank tee assembly 100 allows most internal/external parts of a well pump installation system to be hydraulically and mechanically connected through the tank tee body 102 for better performance;
2. The tank tee assembly 100 allows a water tank to be installed on either the first or second tank legs 110, 112 to the main tank tee passageway 108, or installed on both tank legs 110, 112 to provide a more compact water distribution system;
3. The tank tee assembly 100 allows for variable flow demands when the water distribution system pump is controlled by a variable frequency drive;
4. The tank tee assembly 100 simplifies installation and serviceability of the water distribution system; and
5. The tank tee assembly 100, with its included ball valve assembly 122 and internal poppet valve assembly 146, has less external surface area than a prior art tank tee assembly 10 remotely connected to a prior art ball valve 32 and a prior art check valve 34. As such, relatively less condensation will be generated on the tank tee assembly due to often cold well water.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. A tank tee assembly comprising:
a tank tee body including:
a tank tee inlet, a tank tee outlet and a tank tee passageway therebetween, and
a first tank leg having a first tank leg passageway disposed in fluid communication with the tank tee passageway intermediate the tank tee inlet and tank tee outlet; and
a ball valve assembly including:
a valve body including a valve inlet, a valve outlet and a valve passageway therebetween,
a ball element disposed within the valve passageway,
a ball valve seat disposed within the valve passageway between the tank tee outlet of the tank tee body and the ball element of the ball valve assembly;
wherein the valve inlet is in threaded engagement with the tank tee outlet such that the tank tee body urges the ball valve seat into sealing engagement against the ball element.

2. The tank tee assembly of claim 1 comprising:
the tank tee outlet having:
a male threaded end portion disposed on an outer surface of the tank tee body,
an outer annular shoulder disposed on the outer surface of the tank tee body proximate the male threaded end portion, and
an inner annular shoulder disposed on an inner peripheral surface of the tank tee passageway; and
the valve inlet having a female threaded end portion disposed on an inner peripheral surface of the valve body;
wherein the male threaded end portion of the tank tee outlet is in threaded engagement with the female threaded end portion of the valve inlet such that:
a distal end of the female threaded end portion of the valve inlet abuts against the outer annular shoulder of the tank tee outlet, and
the inner annular shoulder of the tank tee outlet abuts against the ball valve seat.

3. The tank tee assembly of claim 2 comprising:
the male threaded end portion of the tank tee outlet includes male straight threads disposed on the outer surface of the tank tee body;
the female threaded end portion of the valve inlet includes female straight threads disposed on the inner peripheral surface of the tank tee passageway, and an “o” ring groove disposed in the distal end of the female threaded end portion; and
an “o” ring disposed in sealing engagement in the “o” ring groove.

4. The tank tee assembly of claim 1 comprising:
a poppet valve assembly disposed in the tank tee passageway, the poppet valve assembly including a poppet moveable between a closed position and an open position; and
wherein when the poppet is in the closed position a flow of fluid from the tank tee inlet to the tank tee outlet is inhibited, and when the poppet is in the open position the flow of fluid is allowed.

5. The tank tee assembly of claim 4 comprising:
an annular flange disposed on a peripheral surface of the tank tee passageway, the annual flange having a poppet valve seat;
the poppet valve assembly including:
a spring, and
the poppet having a disk and a stem extending from the disk, the disk being resiliently biased by the spring to sealingly engage against the poppet valve seat when the poppet is in the closed position and the disk being disengaged from the poppet valve seat when the poppet is in the open position.

6. The tank tee assembly of claim 5 comprising:
an annular groove disposed in the peripheral surface of the tank tee passageway; and
a guide including:
a sleeve movably engaging the stem as the disk reciprocates from the closed position to the open position, and
support arms extending radially from the sleeve, the support arms having arcuate tabs disposed on distal ends of the support arms;
wherein the tabs are sized to fit within the annular groove to rigidly mount the guide within the tank tee passageway.

7. The tank tee assembly of claim 1 comprising a second tank leg having a second tank leg passageway disposed in fluid communication with the tank tee passageway intermediate the tank tee inlet and tank tee outlet.

8. The tank tee assembly of claim 7 comprising:
a first pair of threaded taps disposed in the first tank leg; and
a second pair of threaded taps disposed in the second tank leg;
wherein the first and second pair of threaded taps are sized to receive a plurality of tank tee accessories.

9. The tank tee assembly of claim 8 wherein the tank tee accessories include at least one of
a pressure gage, a pressure transducer, a relief valve and a drain valve.

10. A tank tee assembly comprising:
a tank tee body including:
a tank tee inlet, a tank tee outlet and a tank tee passageway therebetween, and
a first tank leg having a first tank leg passageway disposed in fluid communication with the tank tee passageway intermediate the tank tee inlet and tank tee outlet; and
a poppet valve assembly disposed in the tank tee passageway, the poppet valve assembly including a poppet moveable between a closed position and an open position; and
wherein when the poppet is in the closed position a flow of fluid from the tank tee inlet to the tank tee outlet is inhibited, and when the poppet is in the open position the flow of fluid is allowed.

11. The tank tee assembly of claim 10 comprising:
an annular flange disposed on a peripheral surface of the tank tee passageway, the annual flange having a poppet valve seat;
the poppet valve assembly including:
a spring, and
the poppet having a disk and a stem extending from the disk, the disk being resiliently biased by the spring to sealing engage against the poppet valve seat when the poppet is in the closed position and the disk being disengaged from the poppet valve seat when the poppet is in the open position.

12. The tank tee assembly of claim 11 comprising:
an annular groove disposed in the peripheral surface of the tank tee passageway; and
a guide including:
a sleeve movably engaging the stem as the disk reciprocates from the closed position to the open position, and
support arms extending radially from the sleeve, the support arms having arcuate tabs disposed on distal ends of the support arms;
wherein the tabs are sized to fit within the annular groove to rigidly mount the guide within the tank tee passageway.

13. The tank tee assembly of claim 10 comprising a second tank leg having a second tank leg passageway disposed in fluid communication with the tank tee passageway intermediate the tank tee inlet and tank tee outlet.

14. The tank tee assembly of claim 10 comprising:
a ball valve assembly including:
a valve body including a valve inlet, a valve outlet and a valve passageway therebetween, the valve inlet having a female threaded end portion disposed on an inner peripheral surface of the valve body,
a ball element disposed within the valve passageway, and
a ball valve seat disposed within the valve passageway between the tank tee outlet and the ball element;
the tank tee outlet having:
a male threaded end portion disposed on an outer surface of the tank tee body,
an outer annular shoulder disposed on the outer surface of the tank tee body proximate the male threaded end portion, and
an inner annular shoulder disposed on an inner peripheral surface of the tank tee passageway;
wherein the male threaded end portion of the tank tee outlet is in threaded engagement with the female threaded end portion of the valve inlet such that:
a distal end of the female threaded end portion of the valve inlet abuts against the outer annular shoulder of the tank tee outlet, and
the inner annular shoulder of the tank tee outlet abuts against the ball valve seat such that the inner annular shoulder urges the ball valve seat into sealing engagement against the ball element.

15. The tank tee assembly of claim 14 comprising:
the male threaded end portion of the tank tee outlet includes male straight threads disposed on the outer surface of the tank tee body;
the female threaded end portion of the valve inlet includes female straight threads disposed on the inner peripheral surface of the tank tee passageway, and an “o” ring groove disposed in the distal end of the female threaded end portion; and
an “o” ring disposed in sealing engagement in the “o” ring groove.

16. The tank tee assembly of claim 10 comprising a second tank leg having a second tank leg passageway disposed in fluid communication with the tank tee passageway intermediate the tank tee inlet and tank tee outlet.

17. The tank tee assembly of claim 16 comprising:
a first pair of threaded taps disposed in the first tank leg; and
a second pair of threaded taps disposed in the second tank leg;
wherein the first and second pair of threaded taps are sized to receive a plurality of tank tee accessories.

18. A tank tee assembly comprising:
a tank tee body including:
a tank tee inlet, a tank tee outlet and a tank tee passageway therebetween,
a first tank leg having a first tank leg passageway disposed in fluid communication with the tank tee passageway intermediate the tank tee inlet and tank tee outlet, and
a second tank leg having a second tank leg passageway disposed in fluid communication with the tank tee passageway intermediate the tank tee inlet and tank tee outlet;
a ball valve assembly including:
a valve body including a valve inlet, a valve outlet and a valve passageway therebetween,
a ball element disposed within the valve passageway, and
a ball valve seat disposed within the valve passageway between the tank tee outlet and the ball element; and
a poppet valve assembly disposed in the tank tee passageway, the poppet valve assembly including a poppet moveable between a closed position and an open position;
wherein the valve inlet is in threaded engagement with the tank tee outlet such that the tank tee body urges the ball valve seat into sealing engagement against the ball element; and
wherein when the poppet is in the closed position a flow of fluid from the tank tee inlet to the tank tee outlet is inhibited, and when the poppet is in the open position the flow of fluid is allowed.

19. The tank tee assembly of claim 18 comprising:
a first pair of threaded taps disposed in the first tank leg; and
a second pair of threaded taps disposed in the second tank leg;
wherein the first and second pair of threaded taps are sized to receive a plurality of tank tee accessories.

20. The tank tee assembly of claim 19 wherein the tank tee accessories include at least one of a pressure gage, a pressure transducer, a relief valve and a drain valve.
